(19) United States
(12) Patent Application Publication
(10) Pub. No.: US 2009/0136065 A1
(43) Pub. Date: May 28, 2009

(54) COMPOSITE SPEAKER AND ITS MANUFACTURING METHOD

(75) Inventor: Hiroshi Yano, Mie (JP)

Correspondence Address: RATNERPRESTIA, P.O. BOX 980, VALLEY FORGE, PA, 19482, US

(73) Assignee: Matsushita Electric Industrial Co., Ltd, Osaka (JP)

(21) Appl. No.: 12/096,956

(22) PCT Filed: Mar. 7, 2007
(86) PCT No.: PCT/JP2007/054427

§ 371 Date: Jun. 11, 2008

(30) Foreign Application Priority Data
Mar. 13, 2006 (JP) 2006-067166
Mar. 13, 2006 (JP) 2006-067167

(51) Int. Cl. H04R 1/00; H04R 31/00

(52) U.S. Cl. 381/186; 29/594

(57) ABSTRACT

A composite loudspeaker has a first loudspeaker and a second loudspeaker. The first loudspeaker has a first frame and a first voice coil, and the second loudspeaker has a second frame stacked on the first loudspeaker and a second voice coil. The first frame has first external connecting sections that are connected to respective terminals of the first voice coil. The second frame has second external connecting sections that are connected to terminals of second voice coil. The first external connecting sections and the second external connecting sections are disposed on substantially the same plane.

This application is a U.S. National Phase Application of PCT International Application PCT/JP2007/054427.

### TECHNICAL FIELD

The present invention relates to a composite speaker (loudspeaker) having two functions as a loudspeaker used for call or sound amplification in a portable phone or the like and a receiver used for receiving a sound, and relates to its manufacturing method.

### BACKGROUND ART

A portable phone has two types of loudspeakers. One is a loudspeaker for sound amplification allowing a user to hear a ring tone and to listen to a received sound while the user keeps the portable phone away from his/her ear; and Another is a loudspeaker allowing a user to listen to a received sound while the user holds the portable phone on his/her ear. The latter loudspeaker is sometimes called a receiver. Recently, for thinning an apparatus such as a portable phone and reducing man-hour for assembling it, a loudspeaker formed by compositing such two loudspeakers has been provided. A conventional composite loudspeaker is described hereinafter with reference to the side sectional view of FIG. 8. This loudspeaker has frame 1, magnet 2, yoke 3, magnet 15, plate 16, plate 6, diaphragm 9, voice coil 10, diaphragm 11, and voice coil 12.

Hollow cylindrical frame 1 is formed by resin molding. Projecting part 1A projecting toward the center of frame 1 is circumferentially disposed on an intermediate part of an inner peripheral surface of frame 1. The outer periphery of hat-shaped yoke 3 is fixed to the inner periphery of frame 1. Ring-shaped magnet 2 is joined to the flange part of the outer periphery of yoke 3. Columnar magnet 15 is joined to the center part of yoke 3.

Ring-shaped plate 16 is joined onto magnet 2, and forms magnetic gap 7 between yoke 3 and itself. Diaphragm 9 is mounted to one opening end of frame 1 via an outer peripheral edge. One end of voice coil 10 is bonded and coupled to diaphragm 9, and the other end is disposed in magnetic gap 7.

Plate 6 is joined to the lower part of magnet 15. Magnetic gap 8 is formed between plate 6 and yoke 3. Diaphragm 11 is mounted to the other opening end of frame 1 via an outer peripheral edge. One end of voice coil 12 is bonded and coupled to diaphragm 11, and the other end is disposed in magnetic gap 8.

Protector 13 is disposed so as to cover diaphragm 9, and the rim of protector 13 is bonded and coupled to frame 1. Similarly, protector 14 is disposed so as to cover diaphragm 11, and the rim of protector 14 is bonded and coupled to frame 1.

In the composite loudspeaker having the above-mentioned structure, magnet 2, plate 16, and yoke 3 form a first magnetic circuit. The first magnetic circuit, diaphragm 9, and voice coil 10 form a first loudspeaker. A voice signal is fed from the outside (not shown) into voice coil 10. The first loudspeaker is mainly used as a loudspeaker for call. On the other hand, magnet 15, plate 6, and yoke 3 form a second magnetic circuit. The second magnetic circuit, diaphragm 11, and voice coil 12 form a second loudspeaker. A voice signal is fed from the outside (not shown) into voice coil 12. The second loudspeaker is mainly used as a receiver. Such a composite loudspeaker is disclosed in Patent document 1, for example.

In the conventional composite loudspeaker, input parts (terminals) of the voice signals from the outside to voice coils 10 and 12 are centered, and can be simultaneously joined to the output terminals of the voice signal transmitted from the outside. Thus, a flexible wiring board used for a portable phone having the composite loudspeaker can be rationalized, or assembling man-hour can be reduced. However, due to disposing two magnetic circuits on the same plane, it is needed that a sound pressure output from each loudspeaker is set in consideration of the balance between magnet 2 and magnet 15. Therefore, the performance of each loudspeaker cannot be set freely.

Patent document 1: Japanese Patent Unexamined Publication No. 2004-343603

### SUMMARY OF THE INVENTION

A composite loudspeaker of the present invention has a first loudspeaker, a second loudspeaker, a pair of first external terminals, and a pair of second external terminals.

The first loudspeaker has a first frame, a first yoke, a first magnet, a first plate, a first diaphragm, and a first voice coil. The first frame has a hollow cylindrical shape. The closed-end cylindrical first yoke is mounted to the inner periphery of the first frame. The cylindrical columnar first magnet is bonded and coupled to the bottom of the first yoke. The first plate is bonded on and coupled to the first magnet, and a first magnetic gap is formed between the first plate and the first yoke. The first diaphragm is bonded and coupled to an opening end of the first frame. One end of the first voice coil is disposed in the first magnetic gap, and the other end is bonded and coupled to the first diaphragm.

The second loudspeaker has a second frame, a second yoke, a second magnet, a second plate, a second diaphragm, and a second voice coil. The second frame has a hollow cylindrical shape. The closed-end cylindrical second yoke is mounted to the inner periphery of the second frame. The cylindrical columnar second magnet is bonded and coupled to the bottom of the second yoke. The second plate is bonded and coupled to the second magnet, and a second magnetic gap is formed between the second plate and the second yoke. The second diaphragm is bonded and coupled to an opening end of the second frame. One end of the second voice coil is disposed in the second magnetic gap, and the other end is bonded and coupled to the second diaphragm.

The pair of the first external terminals are mounted to the first frame, and connected to respective terminals of the first voice coil. A first external connecting section is integrally disposed at each first external terminal. The pair of the second external terminals are mounted to the second frame, and connected to respective terminals of the second voice coil. A second external connecting section is integrally disposed at each second external terminal. The second external connecting section is arranged on substantially the same plane as the first external connecting section. Thanks to this arrangement, the first external connecting section and the second external connecting section can be efficiently and electrically connected to external output terminals of sound signals from an apparatus such as a portable phone. In other words, the assembling man-hour to the apparatus can be reduced.

### BRIEF DESCRIPTION OF DRAWINGS

FIG. 1 is a perspective view of a composite loudspeaker in accordance with an exemplary embodiment of the present invention.

FIG. 2 is an exploded perspective view of the composite loudspeaker shown in FIG. 1.

FIG. 3 is a top view of the composite loudspeaker shown in FIG. 1.

FIG. 4 is a side sectional view taken in the line 4-4 of FIG. 3.

FIG. 5 is a side sectional view taken in the line 5-5 of FIG. 3.

FIG. 6 is an exploded perspective view showing the relationship between a first diaphragm and a first frame of the composite loudspeaker of FIG. 1.

FIG. 7A is a top view of a single loudspeaker using the structure of a first loudspeaker of the composite loudspeaker of FIG. 1.

FIG. 7B is a side view of the single loudspeaker of FIG. 7A.

FIG. 7C is a side sectional view taken in the line 7C-7C of FIG. 7A.

FIG. 8 is a side sectional view of a conventional composite loudspeaker.

### DETAILED DESCRIPTION OF PREFERRED EMBODIMENTS

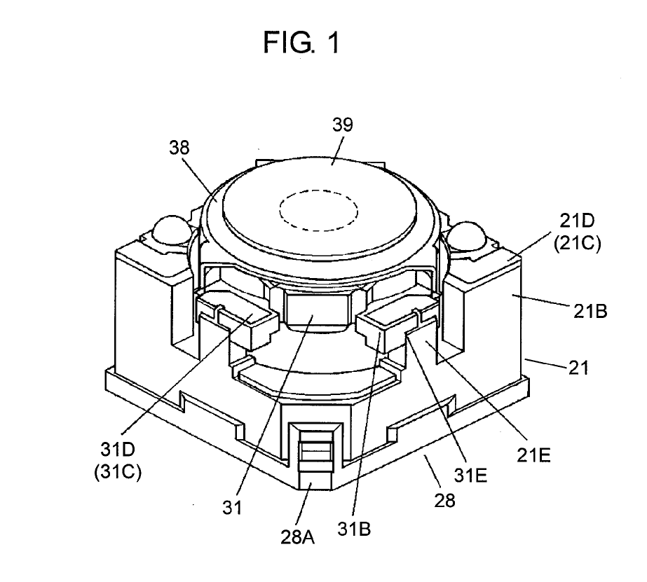

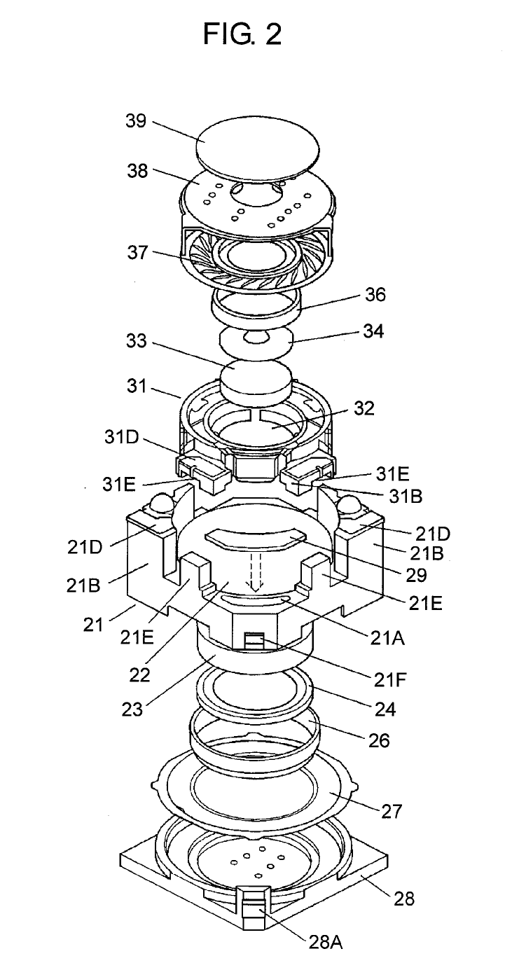

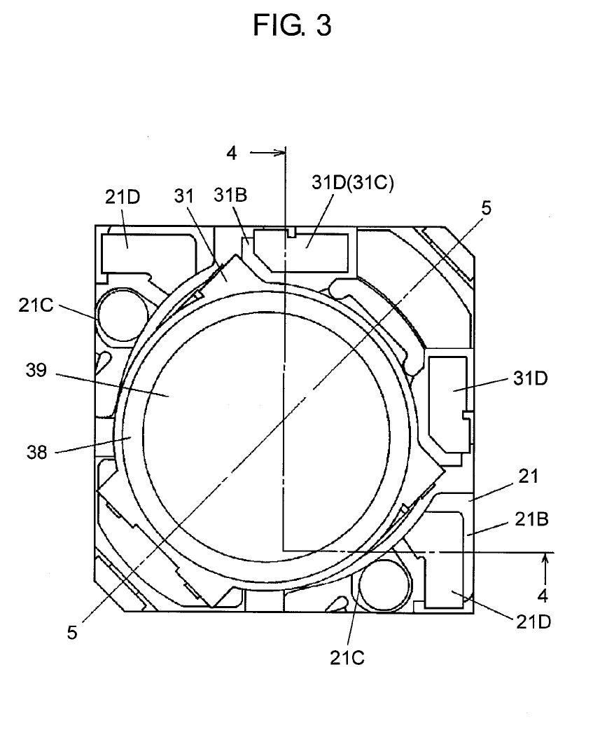

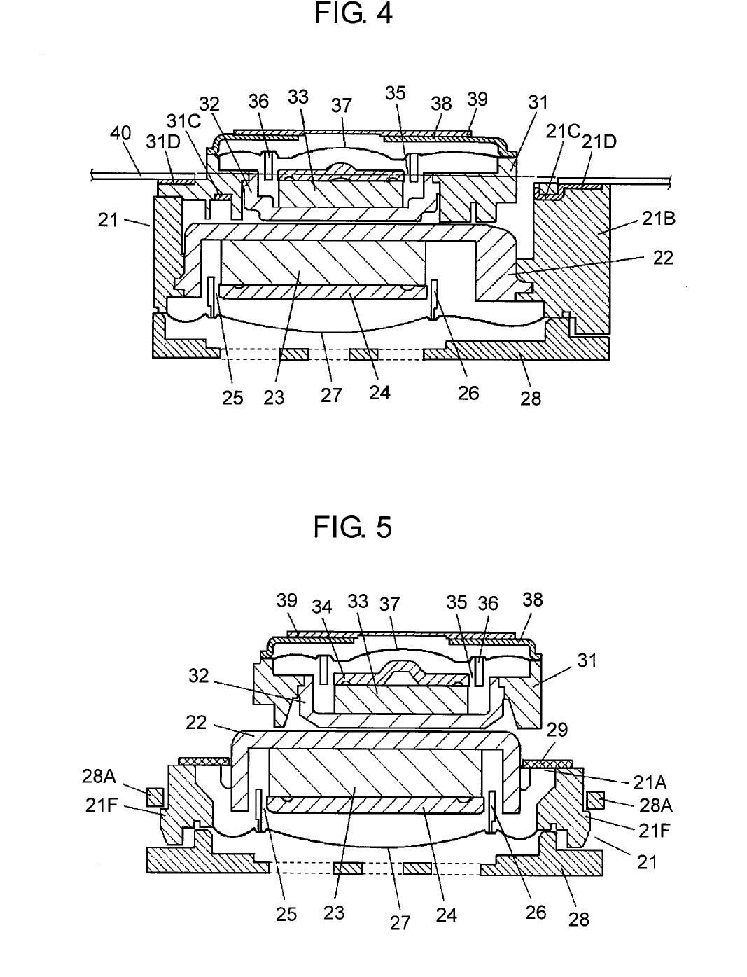

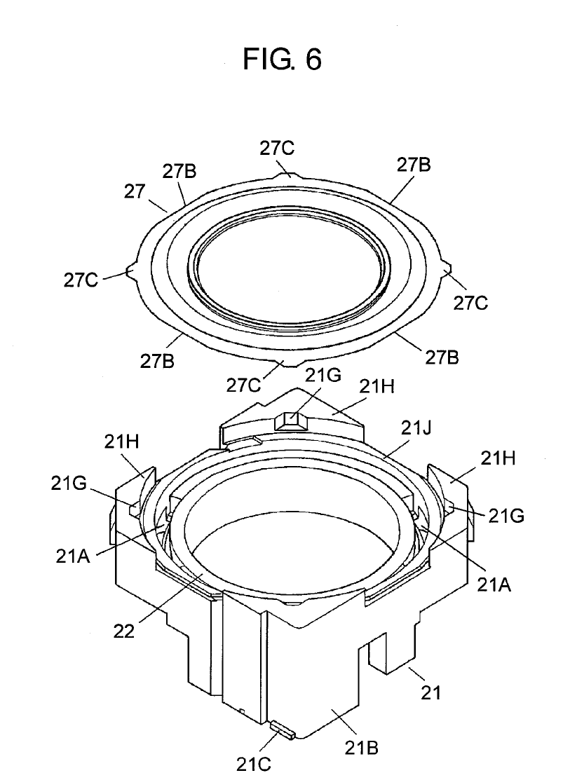

FIG. 1 is a perspective view of a composite loudspeaker in accordance with an exemplary embodiment of the present invention. FIG. 2 is an exploded perspective view of the same. FIG. 3 is a top view of the same. FIG. 4 is a side sectional view taken in the line 4-4 of FIG. 3. FIG. 5 is a side sectional view taken in the line 5-5 of FIG. 3. FIG. 6 is an exploded perspective view showing the relationship between a first diaphragm and a first frame of the composite loudspeaker of FIG. 1. This loudspeaker has first frame 21, first yoke 22, first magnet 23, first plate 24, first voice coil 26, first diaphragm 27, second frame 31, second yoke 32, second magnet 33, second plate 34, second voice coil 36, and second diaphragm 37.

First, a first loudspeaker having first frame 21, first yoke 22, first magnet 23, first plate 24, first voice coil 26, and first diaphragm 27 is described. The outer shape of hollow cylindrical first frame 21 formed by resin molding is a prismatic shape of a substantially square. Closed-end cylindrical first yoke 22 is made of magnetic material such as iron. First yoke 22 is mounted to the inner periphery of first frame 21 by insert molding when first frame 21 is molded. Cylindrical columnar first magnet 23 is made of a permanent magnet such as neodymium magnet, and is bonded and coupled to the bottom of first yoke 22. First plate 24 is bonded and coupled to first magnet 23.

First magnetic gap 25 is formed between first plate 24 and first yoke 22. One end of first voice coil 26 is disposed in first magnetic gap 25, and the other end is bonded and coupled to first diaphragm 27. First diaphragm 27 having an edge on its outer periphery is bonded and coupled to step part 21J disposed on the whole circumference of one opening end of first frame 21, as shown in FIG. 6.

First protector 28 is mounted so as to cover first diaphragm 27. First protector 28 having a plurality of sounding holes is coupled to the one opening end of first frame 21. First protector 28 has a pair of claw parts 28A. First protector 28 is coupled to first frame 21 by engaging claw parts 28A with recessed part 21F formed in first frame 21. Thus, the first loudspeaker is structured.

Back surface sounding holes 21A are disposed at the corners of first frame 21 on a diagonal line. Each of back surface sounding holes 21A passes through first frame 21 to the first diaphragm 27 side, allow sounding and air suction/exhaust when first diaphragm 27 is driven, and contribute to smooth driving of first diaphragm 27.

Damping cloth 29 made of mesh fabric are bonded so as to back surface sounding holes 21A. The sounding amount and air suction/exhaust amount can be adjusted when first diaphragm 27 is driven, by appropriately selecting density of the mesh fabric of damping cloth 29. A damping cloth similar to damping cloth 29 can be bonded to first protector 28 so as to cover sounding holes disposed in it. In this case, the first loudspeaker is used for sound amplification or call, so that the damping cloth is disposed mainly for dust resistant measures rather than braking of sounding.

Next, the structure of a second loudspeaker having second frame 31, second yoke 32, second magnet 33, second plate 34, second voice coil 36, and second diaphragm 37 is described. Second yoke 32 has a closed-end cylindrical shape and is made of iron, namely magnetic material. The bottom surface of second yoke 32 is coupled to that of first yoke 22 by a known method such as bonding. Second yoke 32 is mounted to hollow cylindrical second frame 31 made of resin by insert molding. Cylindrical columnar second magnet 33 is formed of a permanent magnet made of neodymium, and is bonded and coupled to the bottom of second yoke 32. Disk-shaped second plate 34 is bonded and coupled to the upside of second magnet 33.

Second magnetic gap 35 is formed between second plate 34 and second yoke 32. One end of second voice coil 36 is disposed in second magnetic gap 35, and the other end is bonded and coupled to second diaphragm 37. Second diaphragm 37 has an edge on its outer periphery, and is bonded and coupled to one opening end of second frame 31.

Second protector 38 is mounted so as to cover second diaphragm 37. Second protector 38 having a plurality of sounding holes is coupled to the one opening end of second frame 31. Front net 39 is stuck to second protector 38 so as to cover sounding holes disposed in it. Front net 39 is made of cloth of mesh fabric. Front net 39 brakes upward sounding when second diaphragm 37 is driven and prevents dust from entering, by appropriately selecting the mesh fabric. Generally, the second loudspeaker is used as a receiver, so that front net 39 is disposed in order to flatten the sound pressure frequency characteristic in a large range. Similarly to first frame 21, second frame 31 has back surface sounding holes (not shown), and a damping cloth made of mesh fabric is stuck in order to brake second diaphragm 37.

Next, first frame 21 and second frame 31 are described in detail. A pair of leg parts 21B are formed integrally with first frame 21 at opposite corners thereof when first frame 21 is molded. A pair of first external terminals 21C are mounted to leg parts 21B by insert molding.

The pair of leg parts 21B are disposed oppositely at corners on a diagonal line of first frame 21 while back surface sounding holes 21A are disposed oppositely at corners on another diagonal line of first frame 21. Disposing them at the corners can minimize the increase of area required for installing the loudspeaker in an apparatus such as a portable phone. By disposing the pair of back surface sounding holes 21A at opposite positions, a balance is kept between suction/exhaust pressures from back surface sounding holes 21A, and first diaphragm 27 can be driven stably and vertically. When back surface sounding holes 21A cannot be disposed at opposite positions, it is required to provide the sounding holes (not shown) unevenly in protector 28 so as to keep a balance between suction/exhaust pressures from the sounding holes on both upside and downside of first diaphragm 27. In this structure, the design of the first loudspeaker becomes complicated. Therefore, it is preferable to dispose back surface sounding holes 21A at opposite positions.

Each first external terminal 21C has first external connecting section 21D positioned at the upper end of each leg part 21B. Each first external connecting section 21D as an input section of a voice signal from the outside is directed upward. The other end of each first external terminal 21C has an internal connecting section (not shown) electrically connected to a terminal of first voice coil 26 by soldering or the like.

Second frame 31 has a pair of step parts 31B projecting toward the outer periphery. Step parts 31B are simultaneously formed when second frame 31 is formed by resin molding. A pair of second external terminals 31C are mounted to step parts 31B by insert molding when second frame 31 is formed by resin molding.

Each second external terminal 31C has second external connecting section 31D directed upward. Each second external connecting section 31D as an input section of a voice signal from the outside is disposed on each step part 31B. The other end of each second external terminal 31C has an internal connecting section (not shown) electrically connected to a terminal of second voice coil 36 by soldering or the like.

The height of leg parts 21B and the height of step parts 31B are set so that first external connecting sections 21D and second external connecting sections 31D are arranged on substantially the same plane. Arranging first external connecting sections 21D and second external connecting sections 31D on substantially the same plane facilitates the connection of first external connecting sections 21D and second external connecting section 31D to an output section (not shown) of the voice signals from the outside. Thus, the assembling man-hour of the apparatus can be reduced. In addition, the degree of freedom in designing each of the first and second loudspeakers can be increased.

First external connecting sections 21D and second external connecting sections 31D are exposed in the same direction (upward). Therefore, as shown in FIG. 4, when the output section of the voice signals from the outside is disposed on flexible wiring board 40, first external connecting sections 21D and second external connecting sections 31D can be simultaneously connected to the output section by soldering or the like. Thus, the assembling man-hour of the apparatus can be further reduced.

Leg parts 21B and back surface sounding holes 21A are disposed in first frame 21 on the bottom side of first yoke 22, as discussed above. Each corner of first frame 21 on the first diaphragm 27 side, namely opposite the bottom side of first yoke 22, has wall part 21H having notch part 21G. In other words, each wall part 21H is disposed outside step part 21J and at the corner on each of the diagonal lines of the rectangular shape of first frame 21. Wall parts 21H function as guides when first diaphragm 27 is mounted.

As shown in FIG. 6, step part 21J of first frame 21 is narrow linearly in a part having no wall outside it. Correspondingly to this shape, the outer periphery of first diaphragm 27 is not completely circular, and has linear cut parts 27B. Projecting parts 27C are disposed at positions of first diaphragm 27 that correspond to notch parts 21G in wall parts 21H. By making projecting parts 27C correspond to notch parts 21G, improper insertion of first diaphragm 27 is prevented.

For preventing sound leak and air leak when first diaphragm 27 is vertically driven, it is preferable to dispose step part 21J as an allowance for bonding to first diaphragm 27. When first protector 28 is mounted, step part 213 grips first diaphragm 27 together with first protector 28 therebetween over the whole circumference—including even cut parts 27B. Therefore, the sound leak and air leak are prevented, and mechanical strength is kept. In other words, first protector 28 also contributes to prevention of sound leak and air leak at step part 213. Therefore, the size of the rectangular outer shape of first frame 21 can be made smaller than the diameter of the inner periphery of wall parts 21H.

The opening of each back surface sounding hole 21A on the first diaphragm 27 side is formed in the bottom of the edge of step part 213. The size of the opening is secured so that the openings work as through holes for air supply and exhaust.

As described above, leg parts 21B each mounted with first external terminal 21C, back surface sounding holes 21A, and wall parts 21H on the first diaphragm 27 side are disposed at the corners on the diagonal lines of first frame 21 having a rectangular outer shape. First external terminals 21C and second external terminals 31C are disposed at the corners of the rectangular shape of first frame 21. Back surface sounding holes 21A penetrate first frame 21 at the corners on the diagonal line of the rectangular shape of first frame 21 to the first diaphragm 27 side. These corners are dead space when a circular loudspeaker is mounted on the apparatus. This dead space is used for disposing wall parts 21H for guiding first diaphragm 27, leg parts 21B, and back surface sounding holes 21A. Therefore, comparing with a circular loudspeaker occupying similar space, the sound pressure output can be improved using a larger diaphragm. When a loudspeaker of the same performance is manufactured, the size of the loudspeaker is reduced.

In the above-mentioned description, when first frame 21 and second frame 31 are molded, first yoke 22 and second yoke 32 are mounted to first frame 21 and second frame 31 by insert molding, respectively. However, after molding first frame 21 and second frame 31, first yoke 22 and second yoke 32 may be mounted to them by press fit, bonding, or both of them. When first external terminals 21C and second external terminals 31C are mounted to leg parts 21B of first frame 21 and step parts 31B of second frame 31, similarly, insert molding, press fit, bonding, or combination of them can be selected appropriately.

In this embodiment, a composite loudspeaker is formed of the first loudspeaker and second loudspeaker by assembling components. However, the present invention is not limited to this. A composite loudspeaker may be manufactured by separately assembling the first loudspeaker and second loudspeaker and then by bonding and fixing first frame 21 and second frame 31 so that first yoke 22 faces second yoke 32. In this manufacturing method, the composite loudspeaker can be manufactured after removing a first loudspeaker and second loudspeaker that have been controversial in quality in respective manufacturing processes, and the production efficiency and production yield can be improved. Therefore, this manufacturing method is preferable.

In this manufacturing method, a composite loudspeaker is manufactured as follows, for example. First, first yoke 22 is mounted in first frame 21, and first magnet 23 is bonded and coupled to the bottom of first yoke 22. Next, first plate 24 is bonded and coupled onto first magnet 23, and first magnetic gap 25 is formed between first plate 24 and first yoke 22. First diaphragm 27 is bonded and coupled to the opening end of first frame 21, one end of first voice coil 26 is disposed in first magnetic gap 25, and the other end of first voice coil 26 is bonded and coupled to first diaphragm 27. Respective terminals of first voice coil 26 are connected to the pair of first external terminals 21C. Thus, a first loudspeaker is assembled.

On the other hand, second yoke 32 is mounted in second frame 31, and second magnet 33 is bonded and coupled to the bottom of second yoke 32. Next, second plate 34 is bonded and coupled onto second magnet 33, and second magnetic gap 35 is formed between second plate 34 and second yoke 32. Second diaphragm 37 is bonded and coupled to the opening end of second frame 31, one end of second voice coil 36 is disposed in second magnetic gap 35, and the other end of second voice coil 36 is bonded and coupled to second diaphragm 37. Respective terminals of second voice coil 36 are connected to the pair of second external terminals 31C. Thus, a second loudspeaker is assembled, aside from the first loudspeaker. Finally, the first and second loudspeakers are assembled so that the bottom surface of first yoke 22 faces that of second yoke 32. In other words, first frame 21 is bonded and coupled to second frame 31 so that the bottom surface of first yoke 22 faces that of second yoke 32. Alternatively, the bottom surface of first yoke 22 is bonded and coupled to the bottom surface of second yoke 32.

As shown in FIG. 2, it is preferable that positioning sections 21E are disposed in first frame 21, and lower positioning sections 31E each engaging with positioning section 21E are disposed in step parts 31B of second frame 31. When positioning section 21E is butted on lower positioning section 31E, the positional relationship between the first and second loudspeakers can be easily set. The productivity of coupling the first loudspeaker to the second loudspeaker is thus improved.

First magnet 23 and second magnet 33 are vertically magnetized to be permanent magnets. When they are magnetized so that they repulse each other in the completely manufactured composite loudspeaker, it is required to couple the first loudspeaker to the second loudspeaker against the repulsion between the magnets. This layout reduces the leakage fluxes of the first and second loudspeakers to improve the sound pressure outputs thereof.

While, first magnet 23 and second magnet 33 are magnetized so that they attract each other, the attraction between these magnets allows relatively easy coupling between the first and second loudspeakers. Generally, second magnet 33 on the receiver side is relatively smaller than first magnet 23 on the loudspeaker side for sound amplification. Therefore, the magnetic flux on the second loudspeaker side leaks to the first loudspeaker side, the sound pressure output of the first loudspeaker increases, and that of the second loudspeaker decreases. Since the second loudspeaker as the receiver does not require a relatively large sound pressure output, the sound pressure output of the first loudspeaker can be made larger than that before the coupling by actively setting the magnetizing direction so as to cause attraction. Thus, the magnetizing direction is appropriately selected effectively using the above-mentioned features in response to the state of the mounting apparatus, and an efficient composite loudspeaker can be formed.

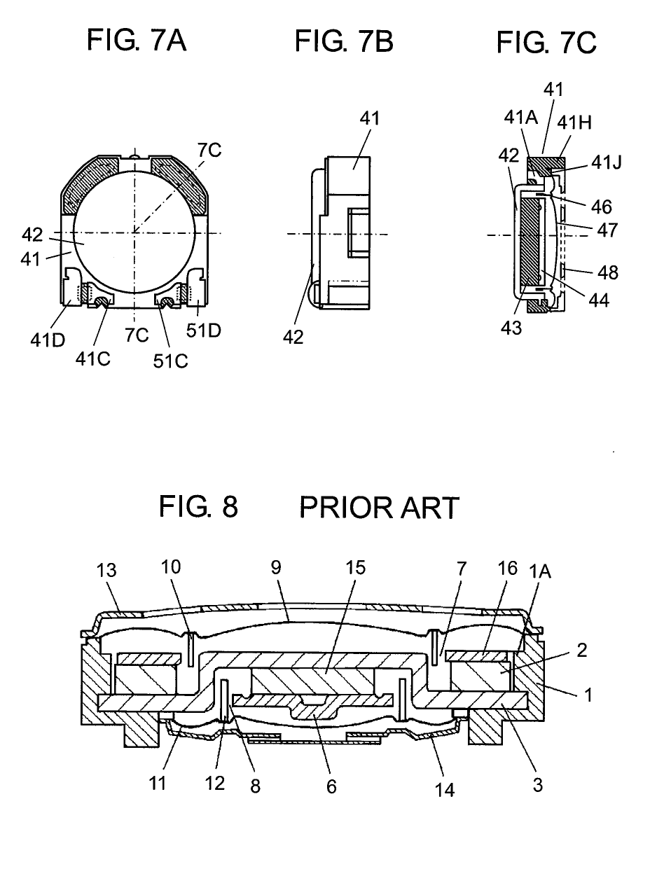

The structure of first frame 21 in the first loudspeaker may be applied to not only the composite loudspeaker but also a single loudspeaker. FIG. 7A is a plan view of the single loudspeaker. FIG. 7B is a side view of the same. FIG. 7C is a sectional view taken in the line 7C-7C of FIG. 7A. This loudspeaker has frame 41, yoke 42, magnet 43, plate 44, voice coil 46, and diaphragm 47.

The outer shape of hollow cylindrical frame 41 is a prismatic shape of a substantially square. Yoke 42 is mounted to the inner periphery of frame 41 by insert molding when frame 41 is molded. Cylindrical columnar magnet 43 is bonded and coupled to the bottom of yoke 42. Plate 44 is bonded and coupled to magnet 43. Magnetic gap 45 is formed between plate 44 and yoke 42. One end of voice coil 46 is disposed in magnetic gap 45, and the other end is bonded and coupled to diaphragm 47.

First diaphragm 47 is bonded and coupled to step part 41J disposed on the inner rim of one opening end of frame 41. Protector 48 is mounted so as to cover diaphragm 47. Protector 48 having a plurality of sounding holes is coupled to the one opening end of frame 41. Wall parts 41H are disposed outside step part 41J of frame 41 and at corners on the diagonal lines of frame 41. Wall parts 41H function as guides when diaphragm 47 is mounted.

For preventing sound leak and air leak when diaphragm 47 is vertically driven, it is preferable to dispose step part 41J as an allowance for bonding to diaphragm 47. When protector 48 is mounted, step part 41J grips diaphragm 47 together with protector 48 therebetween over the whole circumference. Therefore, the sound leak and air leak are prevented, and mechanical strength is kept. In other words, protector 48 also contributes to prevention of sound leak and air leak at step part 41J. Therefore, the size of the rectangular outer shape of frame 41 can be made smaller than the diameter of the inner periphery of wall parts 41H.

External terminals 41C and 51C are mounted to corners of frame 41 by insert molding. External terminals 41C and 51C have external connecting sections 41D and 51D as input sections of a sound signal from the outside, respectively. External terminals 41C and 51C are electrically connected to respective terminals of voice coil 46.

Remaining corners of frame 41 have back surface sounding holes 41A, respectively. Back surface sounding holes 41A penetrate frame 41 to the diaphragm 47 side, allow sounding and air suction/exhaust when diaphragm 47 is driven, and contribute to smooth driving of diaphragm 47.

Thus, each corner of frame 41 has one of external terminals 41C and 51C and back surface sounding hole 41A. Disposing them at the corners can minimize the increase of area required for installing the loudspeaker in an apparatus. In FIG. 7A, back surface sounding holes 41A are disposed at adjacent corners of frame 41. However, it is preferable that back surface sounding holes 41A are disposed at opposite positions on a diagonal line of frame 41, similarly to FIG. 6. In this case, external terminal 41C is also disposed at opposite positions on another diagonal line of frame 41.

As discussed above, external terminals 41C and 51C, back surface sounding hole 41A, and wall parts 41H are disposed at the corners on the diagonal lines of frame 41 having a rectangular outer shape. These corners become dead space when a circular loudspeaker is mounted on the apparatus. This dead space is used for disposing wall parts 41H for guiding diaphragm 47, external terminals 41C and 51C, and back surface sounding holes 41A. Therefore, comparing with a circular loudspeaker occupying similar space, the sound pressure output can be improved using a larger diaphragm. When a loudspeaker of the same performance is manufactured, the size of the loudspeaker can be reduced.

### INDUSTRIAL APPLICABILITY

The present invention can increase the degree of freedom in designing each single loudspeaker while keeping the efficiency of assembling work of a composite loudspeaker to an apparatus. Therefore, the composite loudspeaker is suitable for an apparatus such as a portable phone having a plurality of loudspeakers.

1. A composite loudspeaker comprising:
a first loudspeaker including:
a hollow cylindrical first frame;
a closed-end cylindrical first yoke mounted to an inner periphery of the first frame;
a cylindrical columnar first magnet bonded and coupled to a bottom of the first yoke;
a first plate bonded and coupled to the first magnet, the first plate forming a first magnetic gap between the first plate and the first yoke;
a first diaphragm bonded and coupled to an opening end of the first frame; and
a first voice coil having two ends, one of the ends being disposed in the first magnetic gap and another of the ends being bonded and coupled to the first diaphragm;
a second loudspeaker including:
a hollow cylindrical second frame;
a closed-end cylindrical second yoke mounted to the inner periphery of the second frame, a bottom surface of the second yoke being coupled to a bottom surface of the first yoke;
a cylindrical columnar second magnet bonded and coupled to a bottom of the second yoke;
a second plate bonded and coupled to the second magnet, the second plate forming a second magnetic gap between the second plate and the second yoke;
a second diaphragm bonded and coupled to an opening end of the second frame; and
a second voice coil having two ends, one of the ends being disposed in the second magnetic gap and another of the ends being bonded and coupled to the second diaphragm;
a pair of first external terminals mounted to the first frame, and connected to respective terminals of the first voice coil;
first external connecting sections integrally disposed with the first external terminals;
a pair of second external terminals mounted to the second frame, and connected to respective terminals of the second voice coil; and
second external connecting sections integrally disposed with the second external terminals, and arranged on substantially a same plane as the first external connecting sections.

2. The composite loudspeaker according to claim 1 further comprising:
a first protector coupled to the opening end of the first frame so as to cover the first diaphragm, and provided with sounding holes; and
a second protector coupled to the opening end of the second frame so as to cover the second diaphragm, and provided sounding holes.

3. The composite loudspeaker according to claim 1, wherein
the first external terminals and the second external terminals are exposed in a same direction.

4. The composite loudspeaker according to claim 1, wherein
a magnetizing direction of the first magnet and a magnetizing direction of the second magnet are set so that the first magnet and the second magnet repulse each other.

5. The composite loudspeaker according to claim 1, wherein
a magnetizing direction of the first magnet and a magnetizing direction of the second magnet are set so that the first magnet and the second magnet attract each other.

6. The composite loudspeaker according to claim 1, wherein
the first frame has a rectangular outer shape, has a step part on an inner rim of the first frame, and has a wall part outside the step part and at a corner on a diagonal line of the rectangular shape, and
the first diaphragm is bonded and coupled to the step part.

7. The composite loudspeaker according to claim 1, wherein
the first frame has a rectangular outer shape, and the first external terminals and the second external terminals are disposed at corners of the rectangular shape.

8. The composite loudspeaker according to claim 1, wherein
a pair of back surface sounding holes reaching the first diaphragm side are disposed at corners on a diagonal line of a rectangular shape of the first frame.

9. A manufacturing method of a composite loudspeaker comprising:
assembling a first loudspeaker by the following steps:
mounting a closed-end cylindrical first yoke into a hollow cylindrical first frame;
bonding and coupling a cylindrical columnar first magnet to a bottom of the first yoke;
bonding and coupling a first plate to the first magnet and forming a first magnetic gap between the first plate and the first yoke;
bonding and coupling a first diaphragm to an opening end of the first frame;
disposing one end of a first voice coil in the first magnetic gap, and bonding and coupling another end of the first voice coil to the first diaphragm; and
connecting a pair of first external terminals to respective terminals of the first voice coil, the first external terminals being mounted to the first frame and disposed integrally with first external connecting sections;
assembling a second loudspeaker aside from the first loudspeaker by the following steps:
mounting a closed-end cylindrical second yoke to a hollow cylindrical second frame;
bonding and coupling a cylindrical columnar second magnet to a bottom of the second yoke;
bonding and coupling a second plate to the second magnet and forming a second magnetic gap between the second plate and the second yoke;
bonding and coupling a second diaphragm to an opening end of the second frame;
disposing one end of a second voice coil in the second magnetic gap, and bonding and coupling another end of the second voice coil to the second diaphragm; and
connecting a pair of second external terminals to respective terminals of the second voice coil, the second external terminals being mounted to the second frame and disposed integrally with second external connecting sections; and
combining the first loudspeaker and the second loudspeaker so that a bottom surface of the first yoke faces a bottom surface of the second yoke.
